(19) United States
(12) Patent Application Publication
(10) Pub. No.: US 2011/0211222 A1
(43) Pub. Date: Sep. 1, 2011

(54) IMAGE PROCESSING APPARATUS, METHOD OF CONTROLLING SAME AND STORAGE MEDIUM STORING PROGRAM FOR SAME

(75) Inventor: Yohei Shogaki, Kawasaki-shi (JP)

(73) Assignee: CANON KABUSHIKI KAISHA, Tokyo (JP)

(21) Appl. No.: 12/996,431

(22) PCT Filed: Nov. 1, 2010
(86) PCT No.: PCT/JP2010/069772

§ 371 Date: Dec. 6, 2010

(30) Foreign Application Priority Data
Dec. 15, 2009 (JP) 2009-284550

(51) Int. Cl. G06F 15/00

(52) U.S. Cl. 358/1.15

(57) ABSTRACT

Disclosed is an image processing apparatus having a web browser for displaying an operation screen provided by a web server. A request is transmitted (S503) to the web server based upon a user operation performed via the operation screen displayed by the web browser. A processing request which is issued by the web server based upon the transmitted request is received (S505) without using the web browser, and an image processing is executed according to the received processing request. A new request is transmitted (S507) to the web server in response to ending of the executed image processing.

### BACKGROUND OF THE INVENTION

1. Field of the Invention

The present invention relates to an image processing apparatus having a web browser for displaying an operation screen provided by a web server, a method of controlling this apparatus and the related program.

2. Background Art

In the prior art, an information processing apparatus such as a personal computer is connected to a web server on a network, and an operation screen provided by the web server is displayed by a web browser with which the information processing apparatus is equipped. In this case, the web browser of the information processing apparatus requests the web server for the operation screen. A web application of the web server responds to the request from the information processing apparatus by transmitting HTML data, which is for causing the web browser to display the operation screen, to the information processing apparatus. As a result, the web browser of the information processing apparatus analyzes the received HTML data and displays the operation screen that is based upon the descriptions in the HTML data. If a user inputs a command via the operation screen displayed by the web browser, the web browser notifies the web server of the input command. The web application of the web server so notified then executes processing in accordance with the command that has been input.

Multifunction peripherals (MFPs) equipped with a scanner and printer have recently come to include those equipped with a web browser of the kind described above. Such an MFP displays an operation screen, which is provided by a web server using the above-described procedure, on the web browser of the MFP, and can accept various commands from the user.

The specification of Japanese Patent Laid-Open No. 2006-127503 proposes art in which a web server provides an operation screen that allows the user to input commands for utilizing various functions possessed by an MFP. In accordance with Japanese Patent Laid-Open No. 2006-127503, the user of the MFP inputs a command with regard to the MFP via the operation screen displayed on the web browser and the web server is notified of the entered command via the web browser of the MFP. The web server so notified requests the MFP to execute various processing in accordance with the contents of the command that has been input by the user. The MFP so requested executes the requested processing. As a result, all menu data for operating the MFP need no longer be held in the MFP, and the menu data can be changed easily at the web server.

Furthermore, the specification of Japanese Patent Laid-Open No. 2006-135644 proposes that a web server provide an operation screen that allows the user to input commands for utilizing various functions possessed by an MFP in a manner similar to that of Japanese Patent Laid-Open No. 2006-127503. In accordance with Japanese Patent Laid-Open No. 2006-135644, when the user of the MFP inputs a command concerning the MFP, the web server is notified of the input command as a request by the web browser of the MFP. On the basis of the input command, the web server so notified creates script in which various processing concerning the MFP is described. The web server notifies the MFP of the script as a response to the request from the web browser.

In general, in a case where a web application of a web server executes processing based upon a command that has been input via an operation screen displayed by the web browser, a new operation is screen is displayed on the web browser in accordance with the end of processing by the web application. In other words, when processing by the web application ends, the web server generates HTML data of an operation screen for notifying of end of processing or of an operation screen for allowing the user to perform the next operation. The web server then transmits the generated HTML data to the web browser as a response to a request from the web browser.

On the other hand, there are instances where a time limit (time-out period) equivalent to a length of time extending from transmission of a request to the web server to receipt of a response from the web server is set in the web browser, which is installed in an information processing apparatus such as a personal computer or MFP. If there is no response from the web server within the time-out period, the web browser executes timeout processing. Timeout processing is processing that nullifies a transmitted request. If a transmitted request is nullified, then, by way of example, the information processing apparatus stops waiting for a response to the transmitted request and a state is attained in which it becomes possible to transmit a new request. Further, there are also cases where processing for discarding the session per se is executed and the resources of the web browser are released.

However, the problem set forth below is conceivable in a case where a request is transmitted to a web server based upon a user operation performed via an operation screen displayed by the web browser of an MFP, and the web server requests the MFP to execute processing based upon this request, as set forth in Japanese Patent Laid-Open No. 2006-127503.

Specifically, the web server is notified of the result of processing executed by the MFP. Upon being notified, the web server transmits HTML data, which is for notifying of the result of processing as a response to the request received from the web browser initially. In a case where processing by the MFP executed based upon a request from the web server takes time, a long period of time is required for the web server to send a response back to the web browser upon receiving the request from the web browser. Accordingly, if the above-mentioned time-out processing is executed by the web browser, the response sent back from the web server will no longer be received by the web browser normally and, as a consequence, the user cannot be notified of the result of processing executed by the MFP.

Further, in Japanese Patent Laid-Open No. 2006-135644 mentioned above, a processing command to be executed by the MFP is received as a response to a request from the web browser of the MFP. In this case, the web browser will receive the response to the request and therefore the web browser will not time out. However, in the case of an arrangement of the kind described in Japanese Patent Laid-Open No. 2006-135644, after the web server delivers script to the MFP as a response, a processing command from the web server to the MFP cannot be changed or aborted unless the web server waits for the next request from the web browser. As a consequence, a processing command from the web application to the MFP is difficult to change or abort dynamically during or after execution of script.

### SUMMARY OF INVENTION

An aspect of the present invention is to eliminate the above-mentioned problems with the conventional technology.

The present invention provides technology for changing or aborting a processing command, by way of example, from a web server while occurrence of time-out is suppressed in accordance with state of execution of processing by an information processing apparatus.

The present invention is its first aspect provides an image processing apparatus having a web browser for displaying an operation screen provided by a web server, the image processing apparatus comprising: transmitting means for transmitting a request to the web server based upon a user operation performed via the operation screen displayed by the web browser; processing means for receiving, without using the web browser, a processing request which is issued by the web server based upon the request transmitted by the transmitting means, and executing an image processing according to the received processing request; controlling means for causing the transmitting means to transmit a new request to the web server in response to ending of the image processing executed by the processing means.

The present invention is its second aspect provides a method of controlling an image processing apparatus having a web browser for displaying an operation screen provided by a web server, the method comprising: a transmitting step of transmitting a request to the web server based upon a user operation performed via the operation screen displayed by the web browser; a processing step of receiving, without using the web browser, a processing request which is issued by the web server based upon the request transmitted in the transmitting step, and executing an image processing according to the received processing request; a controlling step of causing the transmitting step to transmit a new request to the web server in response to ending of the image processing executed in the processing step.

The present invention is its third aspect provides a non-transitory computer-readable storage medium storing a program for causing a computer to function as an image processing apparatus having a web browser for displaying an operation screen provided by a web server, the program for causing a computer to: transmit a request to the web server based upon a user operation performed via the operation screen displayed by the web browser; receive, without using the web browser, a processing request which is issued by the web server based upon the transmitted request, and execute an image processing according to the received processing request; cause to transmit a new request to the web server in response to ending of the executed image processing.

Further features of the present invention will become apparent from the following description of exemplary embodiments with reference to the attached drawings.

### BRIEF DESCRIPTION OF DRAWINGS

FIG. 1 is a diagram illustrating the overall configuration of an information processing system according to a first embodiment of the present invention;

FIG. 2 is a block diagram illustrating the configuration of an MFP according to the first embodiment;

FIG. 3 is a block diagram illustrating the configuration of a web server according to the first embodiment;

FIG. 4 is a diagram useful in describing the software configuration of the information processing system;

FIG. 5 is a sequence diagram illustrating exchange of information between an MFP and a web server;

FIG. 6A is a diagram illustrating an example of a setting screen displayed on a console unit of an MFP;

FIG. 6B is a diagram illustrating an example of HTML data sent back as a response at S504;

FIG. 7 is a flowchart for describing a series of processing steps in which an MFP executes processing requested from a web server according to the first embodiment; and

FIG. 8 is a flowchart for describing a series of processing steps in which an MFP executes processing requested from a web server according to a second embodiment of the present invention.

### DESCRIPTION OF EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

A first embodiment of the present invention will be described first. In the first embodiment, a case will be described in which at the time of processing of an event relating to processing executed by an MFP 101, a request is transmitted from the MFP 101 to a web server by utilizing HTML data received beforehand.

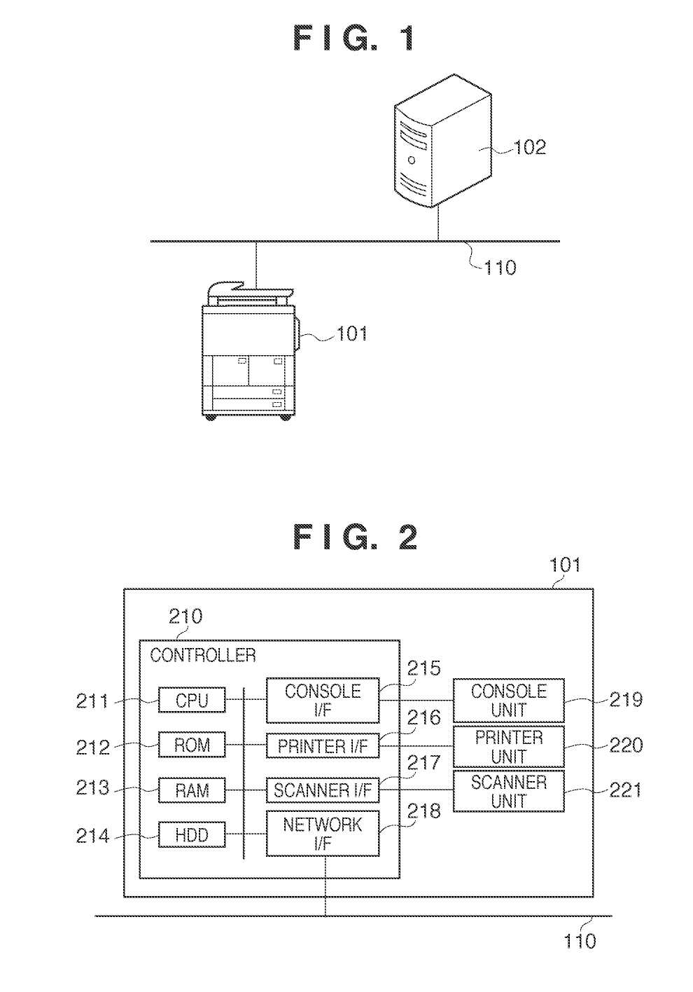

FIG. 1 is a diagram illustrating the overall configuration of an information processing system according to a first embodiment.

The MFP 101 and a web server 102 are connected to a LAN 110 so as to be capable of communicating with each other. The MFP 101 displays an operation screen provided by the web server 102. In the first embodiment the MFP 101 is one example of an information processing apparatus according to the present invention.

FIG. 2 is a block diagram illustrating the configuration of the MFP 101 according to the first embodiment.

A controller 210 that includes a CPU 211 controls the operation of the overall MFP 101. The CPU 211 reads out an operating system and various application programs from a hard-disk drive (HDD) 214 by a boot program stored in a ROM 212, and stores these in a RAM 213. The RAM 213 is used as a temporary storage area such as the main memory and work area of the CPU 211. The HDD 214 stores image data and various programs or various information tables and the like. A console interface (I/F) 215 connects a console unit 219 and the controller 210. The console unit 219 is equipped with a liquid crystal display having a touch-sensitive panel function and with a keyboard, etc. The MFP 101 is further equipped with a web browser function, described later. The web browser of MFP 101 analyzes HTML data received from the web server 102 and displays an operation screen, which is based upon the description in the received HTML data, on a liquid crystal display unit of the console unit 219. A printer interface (I/F) 216 connects a printer unit 220 and the controller 210. Image data to be printed by the printer unit 220 is transferred from the controller 210 to the printer unit 220 via the printer I/F 216 and is printed on a print medium in the printer unit 220. A scanner interface (I/F) 217 connects a scanner unit 221 and the controller 210. The scanner unit 221 reads the image of an original, generates image data and inputs the image data to the controller 210 via the scanner I/F 217. A network interface (I/F) 218 connects the controller 210 (MFP 101) to the LAN 110. The network interface I/F 218 transmits image data and information to an external apparatus (web server 102, for example) on the LAN 110 and receives various information from the external apparatus on the LAN 110.

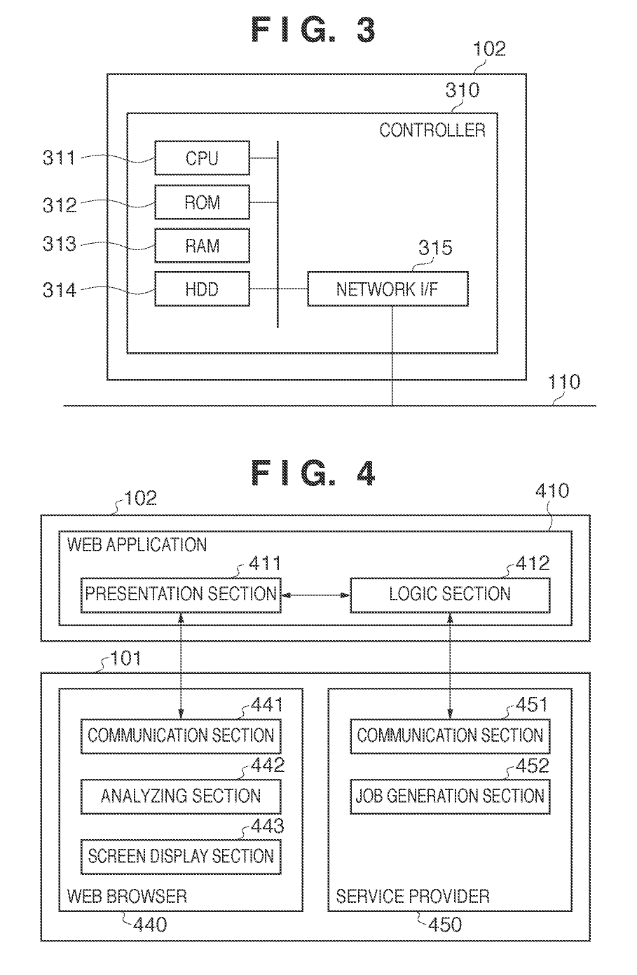

FIG. 3 is a block diagram illustrating the configuration of the web server 102 according to the first embodiment.

A controller 310 that includes a CPU 311 controls the operation of the overall web server 102. The CPU 311 reads out an operating system and various application programs from a hard-disk drive (HDD) 314 by a boot program stored in a ROM 312, and stores these in a RAM 313. The RAM 313 is used as a temporary storage area such as the main memory and work area of the CPU 311. The HDD 314 stores image data and various programs or various information tables. A network I/F 315 connects the controller 310 (web server 102) to the LAN 110. The network I/F 315 sends and receives various information to and from other devices on the LAN 110.

FIG. 4 is a diagram useful in describing the software configuration of the overall information processing system according to the first embodiment. The functional units shown in FIG. 4 are implemented by having the CPUs 211 and 311, which are provided in the MFP 101 and web server 102, respectively, execute programs that have been loaded in the corresponding RAMs.

The software of the MFP 101 will be described first. The software of the MFP 101 is divided broadly into a web browser 440 and service provider 450. The web browser 440 includes a communication section 441, an analyzing section 442 and a screen display section 443. The communication section 441 communicates with a presentation section 411 of a web application 410 of the web server 102 in accordance with the HTTP protocol. The communication section 441 transmits a request to the web application 410 and receives a response (result of processing) transmitted from the web application 410. The analyzing section 442 analyzes the response received from the web application 410. The response includes HTML data and the like. The HTML data includes a description, etc., indicating the contents of an operation screen to be displayed on the web browser 440. The screen display section 443 displays the operation screen on the console unit 219 of MFP 101 based upon the result of analysis of the HTML data by the analyzing section 442.

The service provider 450 includes a communication section 451 and a job generation section 452. The communication section 451 accepts a processing request from a logic section 412 of web application 410. If execution of processing is requested from the web application 410, the job generation section 452 generates a job for executing the requested processing. The job generation section 452 receives a processing request accepted by the communication section 451, generates a job for executing processing requested from the web server 102 and then executes the job.

The software configuration of the web server 102 will be described next. The web server 102 has the web application 410. The web application 410 is implemented by having the CPU 311, which is possessed by the web server 102, execute a program that has been loaded in the RAM 313.

The web application 410 receives information transmitted as a request from the web browser 440 of MFP 101 and executes processing based upon the information received. The result of this processing is transmitted as a response from the web application 410 to the web browser 440. The web application 410 has the presentation section 411 and the logic section 412. The presentation section 411 communicates with the communication section 441 of web browser 440 and receives a request transmitted from the MFP 101. The presentation section 411 notifies the presentation section 411 of the request received from the MFP 101 and waits for a response from the logic section 412. Upon receiving the response from the logic section 412, the presentation section 411 transmits HTML data as a response in accordance with the contents of the response. The logic section 412 executes various processing in accordance with the request sent from the presentation section 411 and requests the MFP 101 to execute processing. More specifically, the logic section 412 requests execution of print processing by the printer unit 220 of MFP 101, execution of read processing by the scanner unit 221 of MFP 101, or execution of transmit processing by the network interface I/F 218. In a case where the logic section 412 requests the MFP 101 to execute processing, it communicates with the communication section 451 of service provider 450 in the MFP 101.

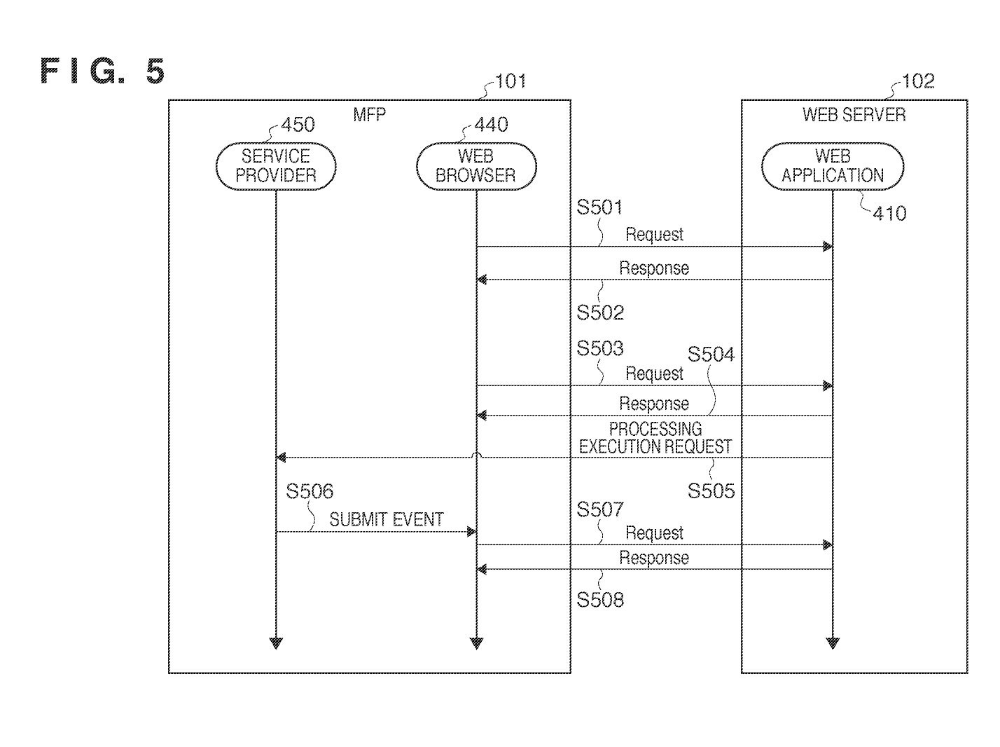

FIG. 5 is a sequence diagram illustrating exchange of information between the MFP 101 and web server 102 in the information processing system according to the first embodiment.

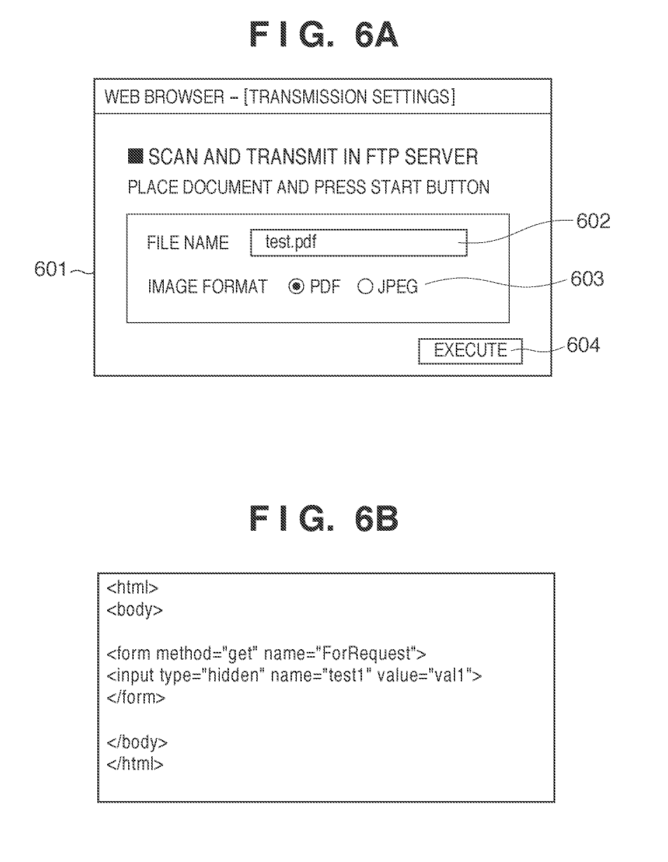

First, at S501, the web browser 440 of MFP 101 transmits a request for HTML data, which displays a screen (see FIG. 6A) for transmission setup in the web browser 440, to the web application 410 of web server 102. As a result, at S502, the web application 410 transmits the result of processing regarding this request together with HTML data to the web browser 440 as a response. The web browser 440 analyzes the HTML data, which is contained in the received response, using the analyzing section 442 and displays the result of analysis using the screen display section 443.

FIG. 6A is a diagram illustrating an example of a setting screen which the web browser 440 displays on the console unit 219 of MFP 101 as a result of the processing at S502 in FIG. 5.

In FIG. 6A, a text box control 602 for setting a file name and radio buttons 603 for selecting an image format are being displayed on a GUI panel 601. In this example, a file name “test.pdf” is appended to image data and the setting is such that the image data is generated in the PDF format by the radio buttons 603. Further, a GUI button 604 is a button that specifies execution of the function. Start of scanning by the scanner unit 221 is specified by pressing of this button by the user.

Next, at S503, the web browser 440 transmits a request instructing execution of processing to the web application 410. The request is transmitted by a user operation performed via the operation screen of FIG. 6A, for example, displayed on the console unit 219. If the user presses the execution button 604, the web browser 440 sends the web application 410 the parameters that have been set in the text box control 602 and radio buttons 603.

Next, at S504, the presentation section 411 of web application 410 creates HTML data, which is displayed by the web browser 440, in accordance with the request made at S503. The HTML data contains a “hidden” form element utilized in event notification from the service provider 450, described later. The presentation section 411 transmits the response together with the created HTML data to the web browser 440. Naturally, since making the form a hidden element is not an essential requirement, the form need not be made a hidden element.

FIG. 6B is a diagram illustrating an example of HTML data constituting the response at S504 in FIG. 5.

Here <form method=“get” name=“ForRequest”> indicates a form of name “ForRequest”, and <input type=“hidden” name=“test1” value=“val1”> indicates the form of a hidden element that is not displayed on the screen.

Further, at S505 in FIG. 5, on the basis of the parameter values necessary for instructing execution of processing and for the execution of the processing contained in the request received at S503, the logic section 412 of web application 410 requests the service provider 450 to execute the above-described processing. The SOAP protocol is utilized in this communication. The service provider 450 receives the request without using the web browser 440. Upon accepting this processing request, the service provider 450 executes processing, such as scanning of the document and file creation in the PDF format, in accordance with the contents of the processing requested. That is, in the example of FIG. 6A, the processing executed includes reading the document using the scanner unit 221, storing the read image data as a PDF file and assigning “test.pdf” as the name of this file.

Next, at S506, the service provider 450 gives notification of a SUBMIT command, as a command that gives rise to an event, to the form contained in the HTML data received by the web browser 440 at S504. It should be noted that in a case where a plurality of forms exist in the HTML data, a form of a predetermined name is notified of the SUBMIT command. At S507, the web browser 440 receives the SUBMIT command of the form and transmits a request to the web application 410. At step S508, the web application 410 transmits the result of processing regarding this request together with HTML data to the web browser 440 as a response. The web browser 440 analyzes the HTML data, which is contained in the received response, using the analyzing section 442 and displays the result of analysis using the screen display section 443.

It should be noted that notification of the SUBMIT command at S506 may be performed at a time specified by the web application 410 (see the second embodiment), at occurrence of an error or at the completion of processing, etc.

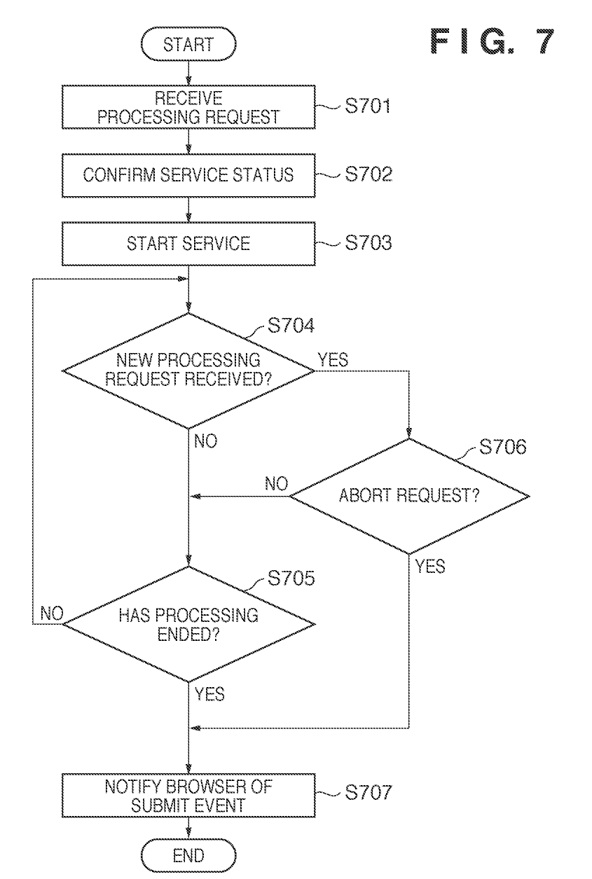

FIG. 7 is a flowchart for describing a series of processing steps in which the service provider 450 of MFP 101 executes processing requested from the web server 102 according to the first embodiment. It should be noted that each operation indicated in the flowchart of FIG. 7 is executed as a result of the CPU 211 of MFP 101 executing a program that has been loaded from the HDD 214 to the RAM 213.

First, at step S701, the communication section 451 of service provider 450 accepts a processing request from the logic section 412 of web application 410. Upon receiving this processing request, the communication section 451 notifies the job generation section 452 of the processing request. Next, at step S702, the job generation section 452, which has accepted the processing request, confirms that the requested processing is in a state executable by the MFP 101. Next, at step S703, the job generation section 452 generates a job for executing the requested processing and then executes the job.

Next, at step S704, the communication section 451 determines whether a new, separate request has been received from the logic section 412 of web application 410. In a case where it is determined that a new, separate request has been received from the logic section 412 of web application 410, processing proceeds to step S706. In a case where it is determined that a new, separate request has not been received from the logic section 412 of web application 410, processing proceeds to step S705. At step S705, the service provider 450 determines whether processing by the service provider 450 has ended. Control proceeds to step S707 if it is determined that processing has ended. At step S706, on the other hand, the service provider 450 determines whether the new, separate processing request received from the web server 102 is a job-abort request. If it is determined at step S706 that the request is a job-abort request, a job-abort command is applied to the job generation section 452. If it is determined at step S706 that the request is not a job-abort request, processing proceeds to step S705. At step S707, the service provider 450 notifies the web browser 440 of a SUBMIT command.

By virtue of the above-described processing, the web application 410 of web server 102 transmits a response without waiting for completion of processing by the service provider 450 of MFP 101. As a result, the web browser 440 is capable of suppressing the occurrence of time-out ascribable to waiting for a response to the request at S503.

Further, owing to this arrangement, the web application 410 of web server 102 is also capable of requesting new, separate processing, namely the aborting of a job or a change to a job, without waiting for a request from the web browser 440 of MFP 101.

Further, in this arrangement, an input field can be prepared as a form, and it is possible for the service provider 450 of MFP 101 to give notification of a SUBMIT command after inputting processing-status information to the form. In this way the processing status of MFP 101 can also be reported to the web server 102.

### Second Embodiment

A second embodiment of the present invention will be described next. Described in the first embodiment is an example in which notification of a SUBMIT command is given when job execution ends or when a job has been aborted. By contrast, in the second embodiment, an example is described in which the timing at which notification of a SUBMIT command is given is set forth in a processing request accepted from the web application 410. The configuration of the system and the configurations of the MFP 101 and web server 102 in the second embodiment are similar to those of the first embodiment and need not be described again.

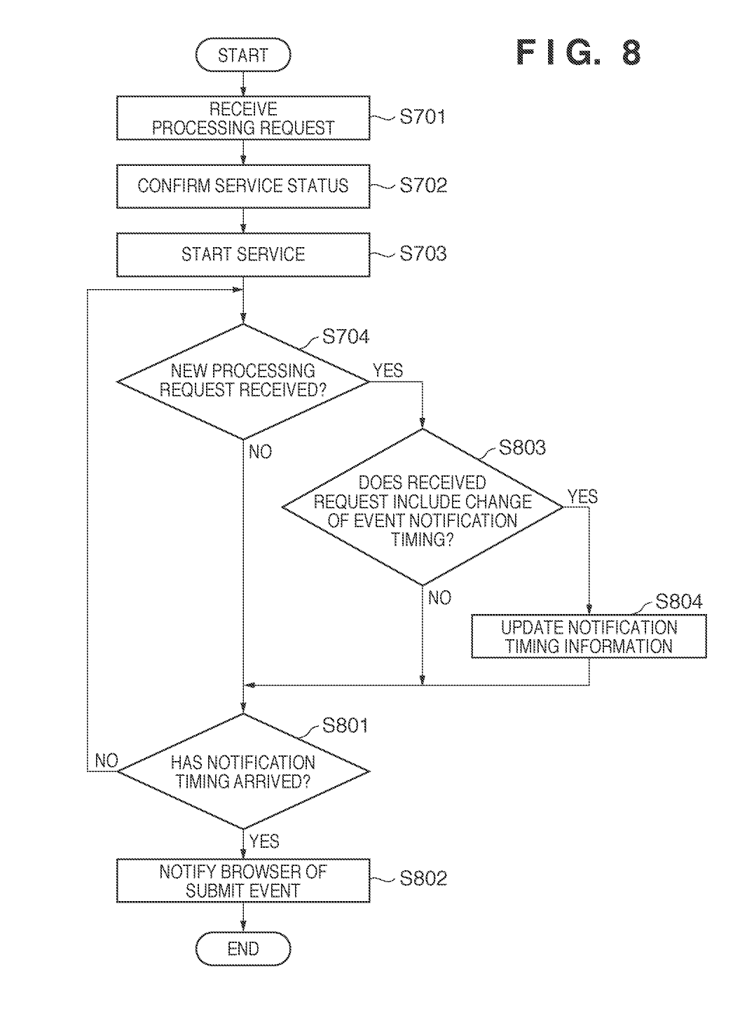

FIG. 8 is a flowchart for describing a series of processing steps in which the service provider 450 executes processing requested from the web server 102 according to the second embodiment. It should be noted that each operation indicated in the flowchart of FIG. 8 is executed as a result of the CPU 211 of MFP 101 executing a program that has been loaded from the HDD 214 to the RAM 213. Processing steps in FIG. 8 identical with those shown in FIG. 7 are designated by like step numbers and need not be described again.

At step S704, the communication section 451 determines whether a new, separate request has been received from the logic section 412 of web application 410. If a separate processing request is received, processing proceeds to step S803. Here the service provider 450 of MFP 101 determines whether the separate processing request received has an entry regarding the timing at which notification is given of a SUBMIT-command event. If it is determined that the separate processing request has an entry regarding the timing at which notification is given of a SUBMIT-command event, processing proceeds to step S804. However, if it is determined that there is no entry regarding the timing of event notification, then processing proceeds to step S801. At step S804, information being held as the timing for giving notification of the SUBMIT-command event is updated by the service provider 450 to the timing that has been set forth in the new, separate processing request received. Processing then proceeds to step S801. At step S801, the service provider 450 refers to the information being held as the timing for giving notification of the SUBMIT-command event and determines whether the event notification timing has arrived. If it is determined that the event notification timing has arrived, processing proceeds to step S802. At step S802, the service provider 450 notifies the web browser 440 of the event by the SUBMIT command.

In accordance with the second embodiment, as described above, the web application 410 of web server 102 is capable of dynamically changing the timing at which the request at S507 in FIG. 5 is accepted. As a result, the web browser 440 of MFP 101 and the web application 410 of web server 102 can exchange information at a desired timing.

An example has been described in which, at step S506 in FIG. 5, the service provider 450 notifies the web browser 440 of a SUBMIT event, whereby a request is transmitted from the web browser 440 to the web application 410. However, the method whereby the service provider 450 gives notification to the web browser 440 is not limited to this method. Another method may be used so long as it provides a trigger for transmitting a request from the web browser 440 to the web application 410. For example, it can be arranged so that the web browser 440 transmits a request to the web application 410 in response to pressing of a specific button on the console unit 219. In this case, the service provider 450 need only notify the web browser 440 of the event which is the pressing of the specific button.

In addition, it may be arranged so that a request is transmitted from the web browser 440 to the web application 410 by executing specific Java (registered trademark) Script. In this case, the service provider 450 may execute specific Java (registered trademark) Script instead of performing event notification by a SUBMIT command at S506 in FIG. 5.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-284550, filed Dec. 15, 2009, which is hereby incorporated by reference herein in its entirety.

1. An image processing apparatus having a web browser for displaying an operation screen provided by a web server, said image processing apparatus comprising:
transmitting means for transmitting a request to the web server based upon a user operation performed via the operation screen displayed by the web browser;
processing means for receiving, without using the web browser, a processing request which is issued by the web server based upon the request transmitted by said transmitting means, and executing an image processing according to the received processing request;
controlling means for causing said transmitting means to transmit a new request to the web server in response to ending of the image processing executed by said processing means.

2. The image processing apparatus according to claim 1, wherein said controlling means further causing said transmitting means to transmit the new request to the web server in response to abortion of the image processing executed by said processing means.

3. The image processing apparatus according to claim 1, wherein the new request is for requesting a new operation screen to be displayed by the web browser.

4. The image processing apparatus according to claim 1, wherein the processing request is transmitted by the web server by using SOAP protocol.

5. A method of controlling an image processing apparatus having a web browser for displaying an operation screen provided by a web server, said method comprising:
a transmitting step of transmitting a request to the web server based upon a user operation performed via the operation screen displayed by the web browser;
a processing step of receiving, without using the web browser, a processing request which is issued by the web server based upon the request transmitted in said transmitting step, and executing an image processing according to the received processing request;
a controlling step of causing said transmitting step to transmit a new request to the web server in response to ending of the image processing executed in said processing step.

6. A non-transitory computer-readable storage medium storing a program for causing a computer to function as an image processing apparatus having a web browser for displaying an operation screen provided by a web server, said program for causing a computer to:
transmit a request to the web server based upon a user operation performed via the operation screen displayed by the web browser;
receive, without using the web browser, a processing request which is issued by the web server based upon the transmitted request, and execute an image processing according to the received processing request;
cause to transmit a new request to the web server in response to ending of the executed image processing.
